(19) United States
(12) Patent Application Publication
(10) Pub. No.: US 2026/0271835 A1
(43) Pub. Date: Sep. 17, 2026

(54) AUTOMATED CART OPERATION

(71) Applicant: Unverferth Manufacturing Co., Inc., Kalida, OH (US)

(72) Inventors: Michael D. VAN MILL, Shell Rock, IA (US); Ron SCHLIMGEN, Shell Rock, IA (US); Jacob Paul MASON, Kalida, OH (US)

(73) Assignee: Unverferth Manufacturing Co., Inc., Kalida, OH (US)

(21) Appl. No.: 19/563,255

(22) Filed: Mar. 11, 2026

Related U.S. Application Data
(60) Provisional application No. 63/771,734, filed on Mar. 14, 2025.

(51) Int. Cl. A01D 90/10

(52) U.S. Cl. CPC A01D 90/10

(57) ABSTRACT

A system is provided. The system includes a cart including a hopper and an unload auger, the hopper having a flow door configured to release material stored in the hopper into the unload auger when in an open condition. The system includes one or more sensors, at least a first sensor of the one or more sensors being configured to measure a rotation rate of the unload auger. The system includes a controller. The system includes processing circuitry configured to: (1) prevent the flow door from opening if the rotation rate of the unload auger is below a threshold and/or the unload auger is in a folded position; and/or (2) close the flow door if the rotation rate of the unload auger is below the threshold.

### CROSS REFERENCE TO RELATED APPLICATIONS

This application claims the benefit under 35 U.S.C. § 119 (e) of the filing date of U.S. provisional patent application Ser. No. 63/771,734, filed Mar. 14, 2025, the disclosure of which is hereby incorporated by reference in its entirety.

### BACKGROUND

### Field of Invention

The present invention relates to automated operation of a cart configured to receive grain from a harvester and unload the grain into a container. More particularly, aspects of the present invention relate to automated operation including automated cart loading, travel to a container, unloading, and/or travel to a harvester.

### Discussion of the Background

Carts shorten harvesting time by improving the efficiency of harvesting equipment such as combine harvesters. Carts transport grain from harvesting equipment in the field to grain trucks or bins at the side of the field. Carts are needed because grain bins are immobile, and grain trucks often do not perform well in muddy or rough field conditions and have the potential to spark fires in dry fields. Carts usually comprise a grain bin (i.e., hopper or box) sitting atop a wheeled frame in combination with an auger means or mechanism for unloading grain from the hopper. Carts handle soft or rough fields with ease and are typically drawn by a tractor alongside a harvester combine, which unloads its contents into the cart. Carts enable a combine to continue harvesting grain while unloading grain into the cart. This unloading on the go increases productivity dramatically because harvester combines do not need to stop to unload. In addition, it is not necessary for the harvester combines themselves to travel to grain trucks or bins at the side of the field each time the harvester combine is full. After a cart is loaded with grain by one or more combines, the grain is unloaded from the cart into a bin for temporary storage or into a waiting grain truck for transport to another location, such as a grain elevator. Because carts offer a combination of economy, versatility, production savings, and maneuverability, carts have been widely accepted by the farmer and widely produced by equipment manufacturers.

### SUMMARY

One aspect of the present invention relates to a system including a cart, one or more sensors, a controller, and processing circuitry. The cart includes a hopper and an unload auger, the hopper having a flow door configured to release material stored in the hopper into the unload auger when in an open condition. The one or more sensors includes at least a first sensor of the one or more sensors being configured to measure a rotation rate of the unload auger. The processing circuitry is configured to (1) prevent the flow door from opening if the rotation rate of the unload auger is below a threshold and/or the unload auger is in a folded position; and/or (2) close the flow door if the rotation rate of the unload auger is below the threshold.

Another aspect of the present invention relates to a system including a cart, one or more sensors, a controller, and processing circuitry. The cart includes a hopper and an unload auger, the hopper and/or auger comprising one or more access points (e.g., cleanout doors, hopper access doors, ladders). The one or more sensors includes at least a first sensor being configured to detect if the one or more access points are in a closed position. The processing circuitry is configured to (1) determine that any of the one or more access points is in the open position; and (2) in response to determining that any of the one or more access points is in the open position, perform one or more of: (i) preventing a tractor power takeoff (PTO) from starting; (ii) stopping the tractor PTO; (iii) engaging one or more clutches to prevent the unload auger from rotating; and (iv) signaling an alert that any of the one or more access points is in the open position.

Another aspect of the present invention relates to a system including a cart, one or more sensors, a controller, and processing circuitry. The cart includes a hopper and an unload auger, the hopper having a flow door configured to release material stored in the hopper into the unload auger when in an open condition. The one or more sensors includes at least a first sensor of the one or more sensors being configured to measure a tractor power takeoff (PTO) speed and a gearbox PTO speed. The processing circuitry is configured to compare the tractor PTO speed and the gearbox PTO speed and (1) adjust the flow door based on the comparison; and/or (2) adjust the tractor PTO speed based on the comparison.

Another aspect of the present invention relates to a system including a cart, one or more sensors, a controller, and processing circuitry. The cart includes a hopper and an unload auger, the hopper having a flow door configured to release material stored in the hopper into the unload auger when in an open condition. The one or more sensors includes at least a first sensor configured to measure a tractor power takeoff (PTO) speed. The processing circuitry is configured to (1) prevent the tractor PTO from starting if the unload auger is not in an unload position; and/or (2) move the unload auger to an unload position prior to allowing the tractor PTO to start.

Another aspect of the present invention relates to a system including a cart, one or more sensors, a controller, and processing circuitry. The cart includes a hopper and an unload auger. The one or more sensors includes at least a first sensor of the one or more sensors being configured to detect obstacles. The processing circuitry is configured to (1) detect an obstacle that may contact and/or damage the unload auger when the unload auger is in an operating position; and (2) stop the cart and/or fold the unload auger in response to detecting an obstacle that may contact and/or damage the unload auger when the unload auger is in an operating position.

Another aspect of the present invention relates to a system including a cart, one or more sensors, a controller, and processing circuitry. The cart includes a hopper and an unload auger. The one or more sensors includes at least a first sensor of the one or more sensors being configured to detect a position of the unload auger and a position of the cart. The processing circuitry is configured to (1) determine if the cart is operating on a field or a road; and (2) adjust a position of the unload auger based on whether the cart is operating on a field or a road and/or signal an alert about whether the cart is operating on a field or road.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 illustrates a perspective view of a grain cart according to an embodiment.

FIG. 2 illustrates a front view of a grain cart according to an embodiment.

FIG. 3 illustrates a side view of a grain cart according to an embodiment.

FIG. 3A illustrates a partial perspective view of a grain cart according to an embodiment.

FIG. 4 illustrates a perspective view of a tractor according to an embodiment.

FIG. 4A illustrates a side view of a joystick according to an embodiment.

FIG. 4B illustrates a front view of a joystick according to an embodiment.

FIG. 4C illustrates a virtual terminal according to an embodiment.

FIG. 5 illustrates a virtual terminal according to an embodiment.

FIG. 6 illustrates an electrical layout according to an embodiment.

FIG. 7 is a flow chart illustrating a process according to some aspects of the present invention.

FIG. 8 is a flow chart illustrating a process according to some aspects of the present invention.

### DETAILED DESCRIPTION OF PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

Embodiments provide for full grain cart automation as well as lesser degrees of automation where a user or operator may be involved to varying degrees. For example, in some embodiments, an operator may be remote from the grain cart but observing the operations via a remote feed which may include a video feed along with other data such as telemetry from one or more sensors. In some embodiments, an operator may be located with the grain cart, but the operator's involvement is limited to monitoring for problems with the automation. In some embodiments, an operator may be located with the grain cart, and directing the grain cart's operation using partially automated assistance provided by the grain cart for one or more grain cart functions.

Embodiments may streamline the grain cart operator experience such as by providing a comprehensive control system, e.g., which may be interacted with via a grain cart application on a virtual interface, mobile device (such as a tablet or smartphone), or otherwise. Embodiments may offer operator assist features that simplify cart operation, e.g., for less experienced operators. Such operator assist features may include automating auger fold, providing diagnostic capabilities, and other such operator assist features described herein. Embodiments may provide operational redundancies for the cart in order to keep harvest operations running. For example, a controller may perform operations (such as folding/unfolding the upper auger or opening/closing the flow door) that an operator may have done, or check to make sure the operations were done at the right time. Embodiments may collect scale data (e.g., grain cart weight, tank weight and/or material weight) and present it to an operator, e.g., in an intuitive interface. Embodiments may integrate with current or future farming operations data management platforms (including platforms such as MyJohnDeere by John Deere, FieldOps by Case IH, and others).

Embodiments may provide operators with a tablet-based interface or a virtual terminal interface. Other interfaces, such as using a smartphone, laptop, or other type of mobile or computing device are also within the scope of disclosed embodiments. In embodiments, the provided interface is intuitive for operators to operate the grain cart. Embodiments are compatible with any load cells, with common agricultural industry electrical connectors, and/or different grain cart designs (e.g., single and double auger grain carts). Embodiments provide for redundancy options for controlling the grain cart. For example, there may be redundancy between or among controllers, such as a grain cart controller and a tractor controller that operate the grain cart and/or tractor. In certain embodiments, these controllers may have overlapping functions. For example, the tractor controller may handle travel through the field and the grain cart controller may handle unloading into the container. In some cases, both controllers may have features to automatically fold/unfold the upper auger (e.g., as the grain cart is traveling through the field or being unloaded). Embodiments provide for the ability to track data in various environments, for example, by tracking load data by field, crop, truck, and bins. Embodiments are compatible with ISOBUS Virtual Terminal displays. In embodiments, any of the functions described herein for a controller may be performed by a grain cart controller, a tractor controller, or by some combination of both a grain cart controller and a tractor controller.

Embodiments may include one or more of the following features which are described further herein:
Automatic logging of events (e.g., unload events) or other grain cart operations and/or diagnostic conditions. These logs may be stored on a memory on the grain cart and/or sent to a remote storage location, such as a remote server or the cloud.
Automatic flow door control, e.g., based on a desired truck fill weight and/or power takeoff (PTO) speed.
Automatic auger fold, e.g., based on home position and/or field movement speed.
Auger fold lockout, e.g., based on PTO speed.
Automatic control for horizontal auger disengagement from the cab.
Weight distribution warnings, e.g., if improperly loaded.
Diagnostic capability to trigger alerts based on various problems or potential problems (e.g., dangerous conditions, grain cart malfunctions, etc.).
Offer a maintenance interval, e.g., based on logged load weights, unload events, and/or unload cycles. For example, a maintenance alert may be triggered based on an unloaded weight threshold. Other events, such as the amount of time spent unloading exceeding a threshold, and/or the accumulated amount of time the PTO/auger RPM is above zero exceeding a threshold, can also trigger a maintenance alert.
Control track belt tension from the system.
Deslug auger assist procedure.
Shut flow door based on ground speed.
Monitoring tire pressure.

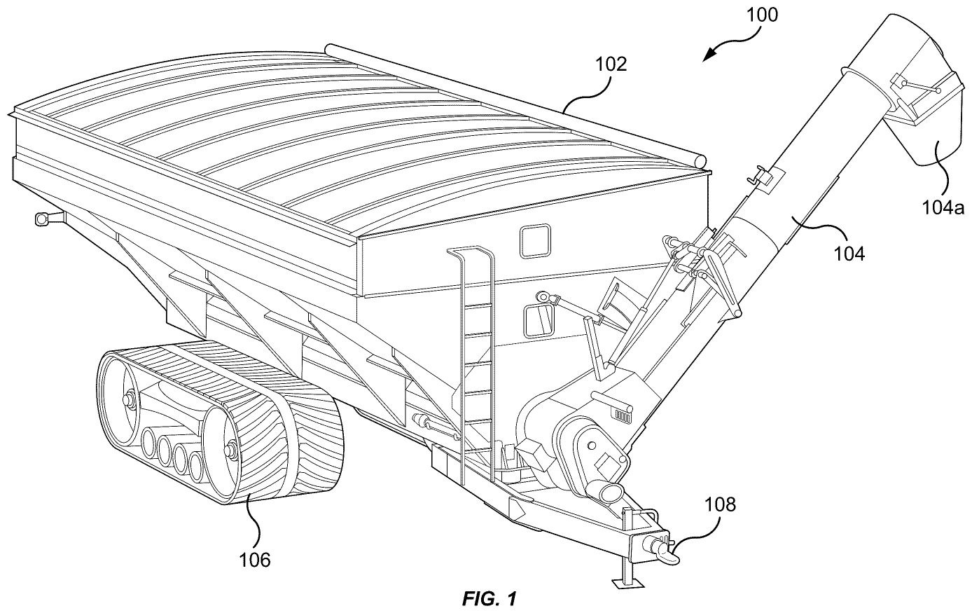

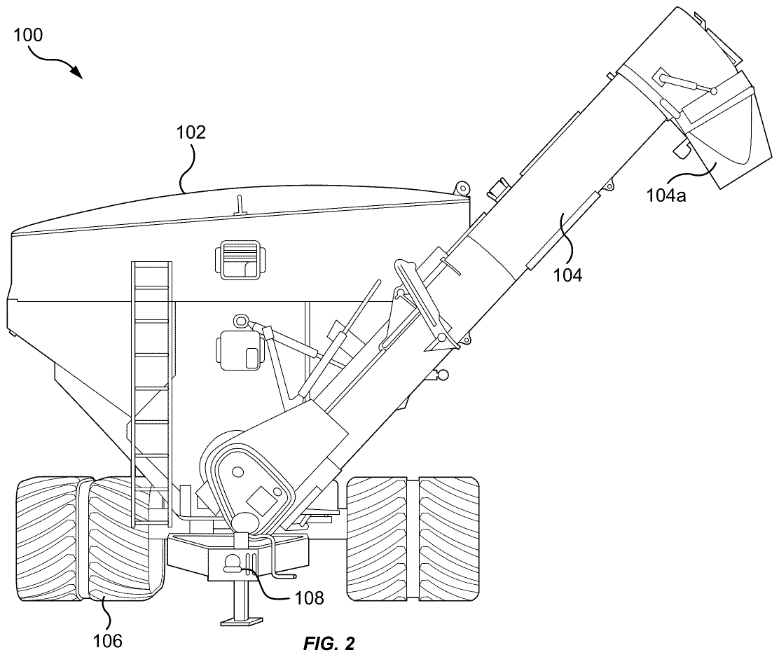

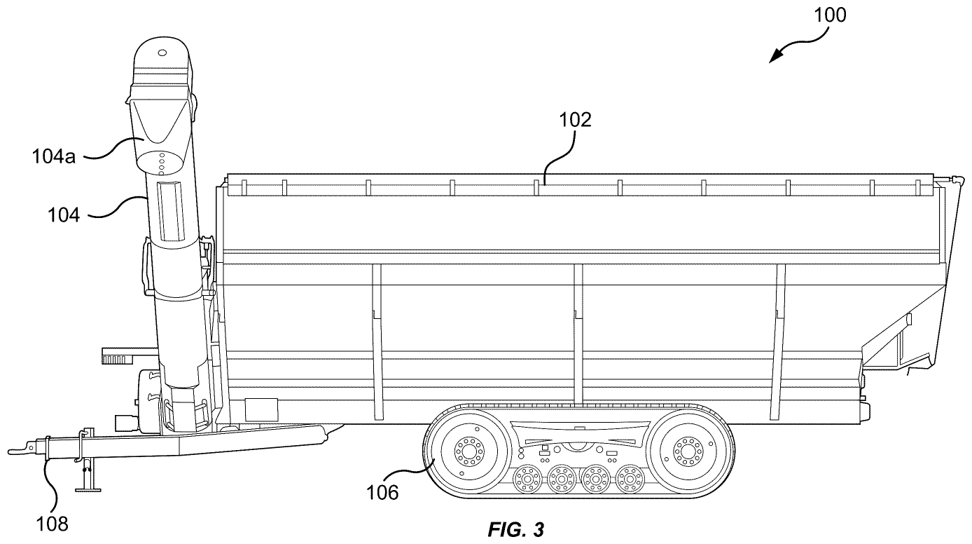

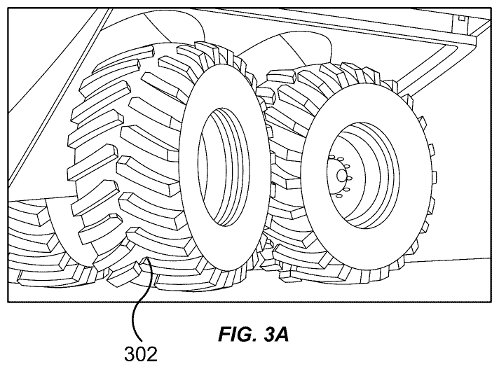

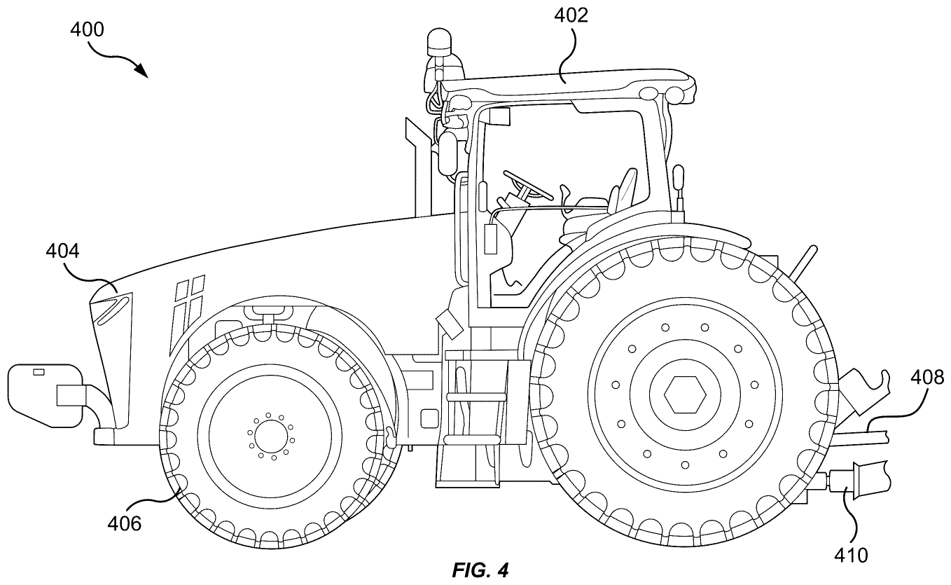

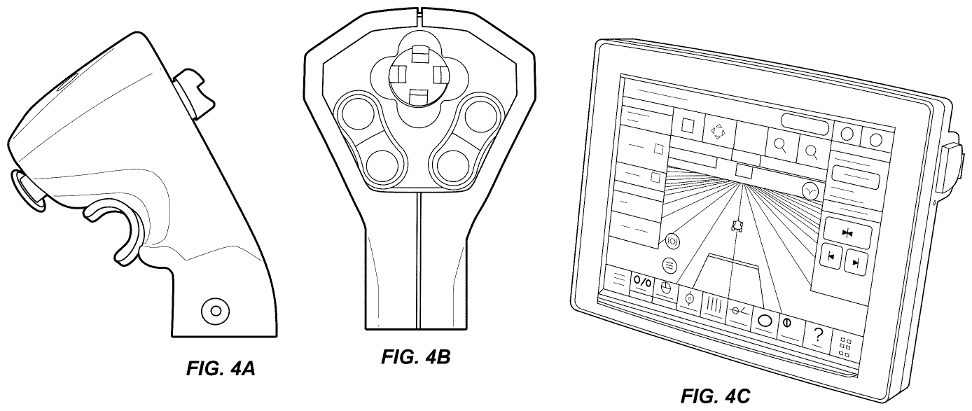

Referring now to FIGS. 1-3, a grain cart 100 according to some embodiments may include a hopper 102 for holding agricultural material, an auger 104, a track assembly 106, and a hitch 108. Hopper 102 may store agricultural material (such as grain) until it is ready to be unloaded. Auger 104 may be used to assist with unloading the hopper 102. Auger 104 may be a single auger, e.g., fed by gravity, or it may be a dual auger, where a horizontal auger moves agricultural material within the hopper 102 to an intake of a vertical auger which then can move the agricultural material through its spout 104a. In some embodiments, a flow door may be used to control the flow of agricultural material out of the hopper and onto an auger. The flow door may be hydraulically operated and may be able to be opened, closed, and/or put in a number of intermediate, partially open positions, e.g., in order to control the rate of flow of the agricultural material from the hopper into the auger. Auger 104 may fold into a stored position and unfold into an operating position. In embodiments, auger 104 may also be able to move between different operating positions, e.g., so as to be able to unload on different sides of the cart (e.g., left-hand or right-hand sides), and/or be able to pivot and/or rotate along one or more axes. Track assembly 106 makes grain cart 100 mobile, facilitating its movement across fields and other surfaces. In some embodiments, wheels 302 (see FIG. 3A) may be employed by grain cart 100 instead of a track assembly 106. In some embodiments, wheels 302 may be in a steering tandem arrangement. Hitch 108 permits the grain cart 100 to be towed, e.g., by a tractor (see FIG. 4).

Several of these features, including grain carts, hoppers, folding augers, track assemblies, and/or hitches are described in U.S. application Ser. Nos. 12/700,372; 14/642,449; 14/662,740; and Ser. No. 16/561,894, the contents of which are herein incorporated in their entirety. Embodiments disclosed herein are applicable to these grain carts, hoppers, folding augers, track assemblies, and hitches, as well as to other grain carts, hoppers, folding augers, track assemblies, and hitches whether currently existing or not.

One or more inputs from grain cart 100 (e.g., from sensors) may be used to support automation. Examples include sensors that can determine the position of the spout 104a of auger 104, e.g., an in-and-out position and a forward-and-back-position. A sensor may be able to determine the position of the flow door. One or more load cells may provide a signal for the front left axle, front right axle, rear left axle, and rear right axle. A sensor may be able to determine a pressure for a valve block (e.g., hydraulic or electric over hydraulic (EOH)). A sensor may be able to determine a gearbox input speed. A sensor may be able to determine a moisture level (e.g., a moisture level of agricultural material within the hopper and/or within the auger). A sensor may be able to determine a pressure of the track, e.g. one sensor to determine a pressure of the right-hand track and another sensor to determine the pressure of the left-hand track. A sensor may be able to determine an auger pivot position, an auger fold position, and an auger unfold position. A load cell may be located in the hitch to provide a hitch load cell signal. A sensor may be able to determine a drive belt tensioner position and/or hydraulic pressure associated with a drive belt cylinder. A sensor may be able to determine a rotation and/or rotation rate (e.g., rotation-per-minute (RPM)) of one or more augers. A sensor may be able to determine if a grain cart tarp is open or closed. A sensor may be able to determine a feedback value for a steerable tandem lock. A sensor may be able to determine track alignment, e.g., based on one or more infrared sensors (including, e.g., a camera).

Various sensors for grain carts are described in U.S. application Ser. Nos. 17/823,306 and 18/325,660; the contents of which are herein incorporated in their entirety. Embodiments disclosed herein are applicable to these sensors, as well as to other sensors whether currently existing or not.

Referring now to FIG. 4, a tractor 400 according to some embodiments may include a cab 402, an engine 404, wheels 406, a PTO 408, and a hitch 410. Cab 402 provides a space for a tractor operator to ride in to operate the tractor. Within the cab 402 there may be a joystick (FIGS. 4A-4B) and a virtual terminal (FIG. 4C). An operator may control the grain cart via the (e.g., wireless) joystick, the virtual terminal, another mobile device such as a tablet or smartphone, or some combination of any of these. Engine 404 may power the tractor and provide torque for the PTO 408. Wheels 406 may help the tractor move. Hitch 410 allows the tractor to tow another implement, such as a grain cart, and PTO 408 may be coupled to the grain cart, such as for powering the grain cart's auger(s). The joystick, virtual terminal, or other interface device may allow an operator operating the tractor 400 to control the grain cart. For example, an operator may be able to command the auger to fold or unfold, and/or may be able to determine the fold and/or unfold condition of the auger based on inputs and/or outputs received from the grain cart 100 by the interface.

One or more inputs from tractor 400 (e.g., from sensors) may be used to support automation. Examples include sensors that can determine a location (e.g., absolute location, such as latitude and longitude, and/or relative location), velocity, and/or acceleration of the tractor 400 (e.g., satellite/GPS-based sensors). Sensors may be able to determine a radar speed, a wheel speed, and/or a PTO output speed. A sensor may be able to determine a reverse gear detection. A sensor may be able to determine various engine related metrics, such as a PTO torque and/or a power load. Sensors may be able to determine auger fold/unfold and/or pivot up/down position information, and similarly, may be able to determine spout forward/backward and/or in/out position information (e.g., commands from a joystick or interface device to control the auger). Sensors may be able to determine flow door open/close position information (e.g., commands from a joystick or interface device to control the flow door). Sensors may be able to determine grain cart steering tandem lock/unlock, and/or grain cart tarp open/close. A sensor may be able to determine an engine RPM.

The grain cart 100 may be controlled, e.g., via tractor 400 and/or otherwise via automation. One or more controllers may be provided (e.g., actuators, pneumatic cylinders, servos, etc.) for controlling various elements of grain cart 100. For example, such controls may include moving the spout 104a in/out, rotating the spout 104/a forward/backward, pivoting the auger 104 up/down, and/or folding the auger in/out. Such controls may also include opening/closing the flow door, extending/retracting the lower auger drive belt, tensioning/de-tensioning the left-hand and/or right-hand track, and/or locking the steerable tandem lock.

Various methods for automating grain carts, control systems, terminals, and interfaces are described in U.S. application Ser. Nos. 15/055,327; 15/425,809; 17/823,306; and Ser. No. 18/325,660; the contents of which are herein incorporated in their entirety. Embodiments disclosed herein are applicable to these methods for automating grain carts, control systems, terminals, and interfaces, as well as to other methods for automating grain carts, control systems, terminals, and interfaces whether currently existing or not.

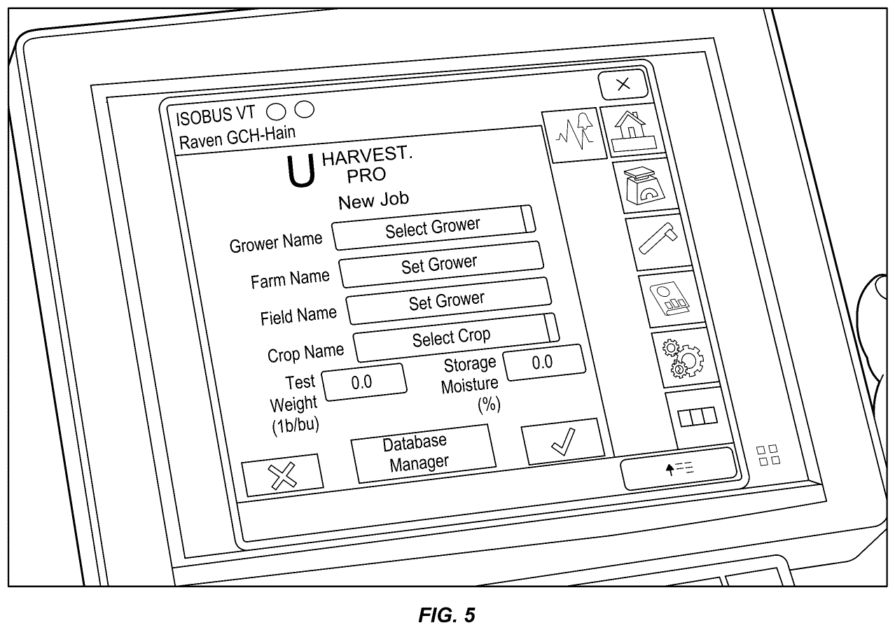

With respect to FIG. 5, an exemplary screen of a virtual terminal or tablet is shown. The terminal or tablet may interface with one or more controllers and allow an operator to monitor current sensor values and see current or historical grain cart operations, as well as allow an operator to initiate grain cart functions. For example, this may include various levels of automated functions, as well as different assist settings that provide information to an operator to assist the operator in performing grain cart functions. The grain cart assist settings can be integrated with the scale functionality, for example, so that an operator may monitor weight information during different grain cart functions such as an unload operation (e.g., to check on flow door positioning and weight distribution). In embodiments, a controller may handle scale functions or may be separate from the scale system.

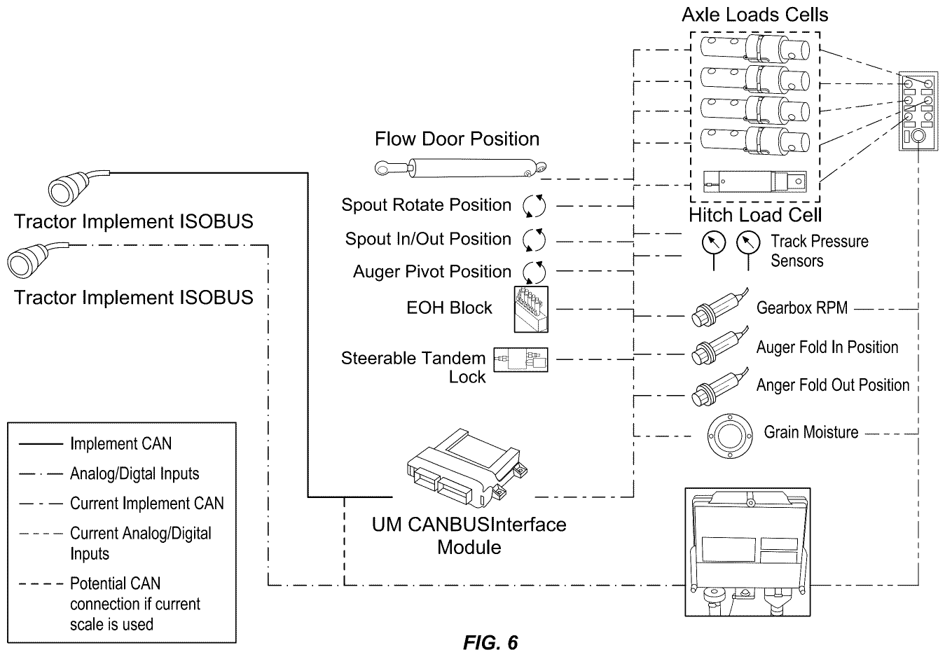

With respect to FIG. 6, an exemplary electrical layout is shown. As shown, the system electrical layout diagram lays out options for how a controller may be set up. The image of the black box in the bottom-right of the figure is a current UHarvest Pro Grain Cart Module (GCM). The lines extending from this box to the right represent the inputs that this GCM currently includes. These are at least the load bars for weight (aka scale system), gearbox and/or PTO RPM sensor for automatically logging an unload event and some automatic flow door functionality, and an optional sensor for measuring the grain moisture in the grain cart or unloaded from the grain cart depending on location. The UM CANBUS Interface Module is a new module that can connect to sensors and/or control grain cart functions such as auger fold, auger tilt, flow door position, and so on. Both the UHarvest Pro GCM and the UM CANBUS Interface Module can connect to the tractor ISOBUS system and can use ISO standard 11783 as a specific type of CANBUS protocol. Other communication methods and protocols could also be used, such as Ethernet. The dashed lines indicate the connection and communication to the tractor can be joined into one ISOBUS line to the tractor. The diagram shows the current the scale information between the tractor and the UM ISOBUS Interface Module but that does not necessarily mean the UM CANBUS Interface Module will not have access to or utilize the scale information. Also, the GCM and the UM CANBUS Interface Module could be combined into one module or controller. The GC module(s) combined, or the UM CANBUS interface Module may also have to work with a tractor controller or a system that already has at least some functionality associated with operating at least some functions of a grain cart.

Several exemplary automated processes are described below in more detail.

Flow door control: The control over the flow door may be automated, for example, by opening or closing the door in certain conditions, including by setting the door to different partially open states in response to certain conditions. For example, one or more of the auger fold position (e.g., folded or unfolded, or a particular operating position if there is more than one), the PTO RPM, the ground speed, and auger (horizontal and/or vertical) rotation and/or RPM may affect the flow door positioning. As one example, if the PTO RPM falls below a lower threshold value after being above an upper threshold value for a set amount of time, then the flow door may automatically be closed. As another example, the amount that the flow door opens may be determined based on the PTO RPM value. For example, as the PTO RPM value increases, the amount the flow door is open may increase, whereas as the PTO RPM value decreases, the amount the flow door is open may decrease. Such adjustments to the positioning of the flow door may first require there to be a minimum change in PTO RPM, may adjust the flow door position at certain fixed values of the PTO RPM, or may adjust the flow door position continuously as the PTO RPM changes. As another example, the flow door may be closed in response to a tractor engine load and/or power reduction meeting a certain threshold and/or a tractor PTO RPM decreasing by or to a certain threshold.

As another example, the flow door positioning may depend at least in part on sensor values coupled to an auger, e.g., drag and/or vertical augers, that sense the auger(s) rotation and/or RPM value. For instance, a process may check to confirm that any augers are rotating, and may also check that one or more auger RPM values are over a certain threshold, under a certain threshold, and/or within a certain range. If augers are not rotating and/or if one or more auger RPM values do not meet set criteria, the flow door may not be permitted to be opened and/or may be closed if it is already opened. These checks may in some embodiments be used to determine if an auger is plugged with grain and not rotating, if the belt tensioner is disengaged, if a broken drive component such as pin or bolt exists, or if there is some other issue. The term “plugged” sometimes is referred to interchangeably herein as “slugged”. In addition to preventing the flow door from opening, or closing the flow door, in these conditions, the system may also alert the operator to a particular problem, such as by signaling an alarm, or providing an indication to check the problematic system component, optionally including a narrative about what is suspected to be wrong and any sensor values supporting the diagnosis.

As another example, both the tractor PTO speed and a gearbox PTO speed may be used to control the flow door position. For instance, the tractor PTO speed may be compared to the gearbox PTO speed to determine if the clutch, typically in the driveline assembly between the tractor and the grain cart, is slipping. If the system determines that the clutch is slipping, then the flow door may be closed in response to this determination and/or the tractor PTO RPM may be adjusted in response to this determination. The nature of the comparison may depend on where the RPM sensor(s) are located on the grain cart. For example, if an RPM sensor is located at the gearbox input shaft, the gearbox PTO speed should be equal to the tractor PTO RPM, such that if their difference exceeds a threshold (e.g., a low threshold such as zero), a controller may determine that there is an issue such as the clutch is slipping.

In some embodiments, one or more sensor(s) (e.g., a camera), may be used to monitor unloading, such as by monitoring agricultural material output from the discharge spout (like spout 104a of auger 104), to determine an appropriate action to take. For instance, in some embodiments, such monitoring may be used to determine if (i) the flow door should be closed, (ii) the unload event should be paused, and/or (iii) if an operator should be notified. This monitoring may be used, for example, in addition to, or as an alternative to comparing input (tractor) PTO RPM to RPM at various grain cart locations, generally after the driveline clutch.

As another example, prior to opening the flow door, the system may confirm that any or all of the cleanout doors on the hopper or auger assembly are in the closed position before opening the flow door. If some are not, then the system may not permit the flow door to be opened. Additionally, if it is determined that some of the cleanout doors are not in the closed position after the flow door has been opened, the flow door may be automatically closed. An alert may be provided to the operator explaining that the status of the cleanout doors is preventing the flow door from being opened.

In some embodiments, prior to allowing the tractor PTO to start, the system may first confirm that the upper auger is in the unload position before starting the tractor PTO. If the upper auger is not in the unload position, the tractor PTO will not be allowed to start. In some embodiments, starting the tractor PTO will automatically trigger the upper auger to move to an unload position.

### Scale Data.

Embodiments may use scale data from various sources. Grain cart scale weight, for example, may indicate the weight of the grain cart (including the hopper and its contents), but the scale may be tared (or zeroed out) when the grain cart hopper is empty and therefore may in some cases display or track the weight of what is loaded into or unloaded out of the grain cart. In many use scenarios, an operator is most concerned with the amount of crop or other agricultural material that is in the hopper or the amount of crop that has been unloaded out of the grain cart, and one or more sensors may be able to provide that information.

In certain embodiments, some automated functions may be based at least in part on weight, and therefore, may make use of scale data. For example, weight may be used as part of some automated functions when a harvester is unloading into the grain cart, while traveling through the field, and when the cart is unloading in the container. In the unloading cases, weight may be used to avoid overloading, either overloading a total weight threshold, or overloading a specific area of the cart or the truck. As another example, during road travel, there may be weight limits on different roads, fields, or other surfaces. For example, there may be a total gross weight limit and/or a weight per axle (or tire) limit to avoid infrastructure damage such as on roads and bridges. There may also be more than one hopper, and weight data can be used to ensure appropriate distribution among the different hoppers.

In the case of the grain cart, weight distribution for stability in the field and overloading a particular area on the cart such as the hitch may be important, and embodiments may use weight data to control weight distribution for stability and/or avoid overloading a particular area on the cart. For example, while the harvester is unloading into the grain cart hopper, the position relationship between harvester and grain cart (e.g., forward, rearward, side to side, as the harvester and grain cart move mostly parallel to each other through the field) may need to change to evenly distribute the harvested crop in the grain cart. One reason is to not overload a particular area or load cell such as the hitch. Certain embodiments may use automated procedures to position the harvester and/or grain cart so as to ensure even loading (e.g., by moving the harvester and/or grain cart, and/or by controlling an auger operating position and/or spout position/rotation).

Scale data may include weight. Weight may be converted to other units of measure. In the US, this is typically bushels while in other countries metric tons is typically used. The weight conversion may be done by using an industry standard conversion. For example, some common US conversions are 56 lbs. per bushel when corn is at 15% moisture. 15% moisture is a common target for long term storage. Wetter and/or drier can lead to spoilage or damage during handling. Some other grain conversion examples are 60 lbs./bu. for wheat & soybeans. Grain dryers can be used to remove moisture from the grain to reach the desired moisture level.

Other information can be included alongside or associated with weight such as moisture. An additional sensor in the hopper and/or on the grain cart auger can read the grain moisture level. The grain moisture information can be used at various stages by different automated functions. One way is for the grain dryer settings and amount of time that grain or other agricultural material needs to spend in the grain dryer to reach a desired moisture level. Another use may be converting wet grain to dry grain due to shrinkage and density change that occurs from removing excess water.

Other information that may be used in connection with weight may include location information such as field information on where the crop was harvested and/or where it was unloaded in the cart. This information can be acquired by collecting GPS data, using relative location information, or the user giving names to the field, or the cart otherwise associating location information.

Additionally, there may be user input involved. For example, a controller may know (e.g., based on location, reading a database, etc.) crop data, name and number of the hybrid, and the grain storage location the crop will end up at or in. In other embodiments a user may input such data (e.g., crop data, name and number of the hybrid, and the grain storage location the crop will end up at or in) during operation of the farm equipment.

Flow Door Positioning Based on Desired Truck Fill Weight and/or PTO Speed, and Automatic Flow Door Control.

Truck fill weight may be used in certain automated operations in order to reach a target weight in the container the grain cart unloads into and/or to evenly distribute the contents in the container. The flow door must be open to start the unloading, and in embodiments may be opened automatically when it is determined that unloading should begin. Shutting the flow door will stop the unloading. In embodiments, the flow door may be shut automatically when it is determined that unloading should stop. For example, the flow door may automatically be shut at intervals based on the truck fill weight. In some cases, unloading may take place into a hopper having multiple sections (e.g., separated by section dividers) and/or into multiple hoppers and/or an additional trailer pulled behind the main truck container (e.g., a Super B (https://www.wilsontrailer.com/trailers/super-b/) or pup-trailers). In certain embodiments, the flow door may be closed as each section of the hopper having multiple sections, or each hopper of the multiple hoppers, reaches its fill weight, such that the flow door is opened and closed multiple times on the way to the final total weight the truck can carry. A controller may know a fill weight for individual hopper sections or hoppers based on user input, reading from a database, a barcode, a wireless signal, and so on, and may be able to determine when it is positioned in front of a new section or hopper such that the flow door should be re-opened. The flow door may also be shut automatically to manage weight distribution over the truck as already mentioned.

The flow door may also be controlled (e.g., by opening and closing the flow door) based on PTO speed. It is common for grain carts to have a torque limit clutch to prevent damage to the drive components. Currently, there are 3 agriculture industry standard PTO RPM's: 540, 1000 and 1200. 540 RPM is an older value and less common. 1000 RPM is currently the most common. 1200 RPM is the newest but currently has limited acceptance. Power for the PTO is provided by an engine and correlates to the engine RPM so when the engine RPM is reduced the PTO RPM is reduced, and when the engine RPM is increased, the PTO RPM is increased. Similarly, the PTO RPM can correlate to the grain cart auger RPM. Auger RPM goes up or down with the engine/PTO RPM, e.g., through gears, belts, roller chains or other mechanical drives. In some cases the augers are driven by hydraulics from the tractor, but even in these cases, the tractor hydraulic flow is based on engine RPM. The engine RPM can be automated or controlled by the user.

Because power (P)=torque (T)×RPM, to have the same amount of power with a slower RPM, more torque is needed. Additionally, a slower auger RPM allows more grain in every auger revolution making for higher load or torque to move the grain in the auger. Typical grain carts driven by PTO are intended to operate at or around the high end of the industry RPM, e.g., 1000 RPM, to keep torque low which keeps drive component size down and/or increases component life. Embodiments may automatically close the flow door when the PTO RPM is less than desired (e.g., 750 RPM when it is designed to operate at or around 1000 RPM), and doing so may help to maintain torque levels. If the PTO/engine RPM goes up, the flow door can go to a more open position.

Similarly, if the engine is run at a lower RPM, the engine has to produce more torque to maintain the same power, which again means larger components and/or reduced life. Engines have limited torque capacity and/or may have controllers that limit torque to protect the engine, or clutches to limit the amount of power transmitted through the tractor PTO. Additionally, the grain cart typically will have a clutch, commonly on the driveline assembly between the tractor PTO and the grain cart, to limit torque. When the tractor engine, PTO, and/or grain cart clutches reach their limits, they decrease, if not completely stop transmitting power and/or RPM leading to excessive grain in the grain cart augers. When the amount of grain in the grain cart is in excess to the point that the grain cart augers stop rotating, that condition is referred to as a slugging event (it can also be said that the augers are plugged). The faster the flow door can react to decreased RPM the more it helps prevent slugging the augers. Since the PTO/auger RPM will start at zero, the torque needed to get the augers and the grain in the augers going will be high compared to normal operating torque.

### Addressing Plugged Grain Cart Augers.

One way to address plugged grain cart augers includes opening the auger cleanout doors and dumping the grain in the augers. Before starting this procedure, the flow door should be shut so that the grain in the container is not emptied. When opening the cleanout doors, the grain is typically dumped on the ground and then has to be either left or picked up by shovels or other equipment. Another way to address plugged grain cart augers includes not driving all the grain cart auger portions in order to reduce the torque demand. In the case of a double auger grain cart, typically the horizontal/drag auger is disengaged. This may be accomplished by some type of clutch or a drive belt tensioner. This allows all of the engine/PTO/driveline clutch torque to be sent to just the vertical unload augers. Once the grain in the vertical augers are empty, the PTO RPMs may be reduced or go to zero and the belt drive tensioner re-engaged to drive the horizontal/drag augers. The PTO may start back up to unload the grain in the horizontal/drag auger and since the vertical auger has no grain, the overall torque is smaller than when both vertical and horizontal auger were full.

In certain embodiments, in part to prevent plugging the grain cart, a controller may determine both the tractor PTO RPM and the grain cart RPM (such as at the auger ends, or after the driveline clutch into a gearbox), and close the flow door based on comparing these two RPM values. By determining the auger RPMs (e.g., based on sensor values), a controller can determine that the augers are in fact rotating, as well as rotating at the proper RPM, as well as determine and react if the clutch is decreasing the RPM coming into the grain cart. Some types of grain cart driveline clutches are friction disk, cam or cut-out, or shear bolts. A friction disk clutch allows some small amount of slippage in response to peak torque values and then goes back to transmitting the intended torque amount once the torque values drop below the limit. The downside to friction disks is they wear and as they wear, the high-end torque limit is decreased. With cam style or cutout clutches, there are cams that kick out when torque is in excess and the RPMs need to be reduced a sizable amount before they will re-engage to allow transmitting of more torque. Shear bolt clutches instantaneously stop transmitting torque when the threshold is exceeded and will not transmit torque until the failed bolt has been replaced.

### Automatic Auger Fold.

Grain carts typically have an auger portion that is unfolded to unload and then folded for transport, at least during road transport. Since these auger portions extend high and outward, they can get damaged and/or cause damage. Some items they may encounter are trees, poles, electrical power or communication lines, other grain cart augers or harvester unload augers. For this reason, operators are typically instructed to fold the foldable portion of the unload auger. Not all operators do this all the time. Since these augers only need to be in the unload position when they are unloading, the controller may, in some embodiments, automatically fold the auger portion once the unload event is done. That the unload event is done may be determined, e.g., based on the grain cart leaving a designated area (a.k.a. a home location), such as a designated auger fold or unload area in the field. The determination that a grain cart has finished unloading (and therefore triggering the automatic auger fold operation) may be based on other factors, alternatively or in addition to a location of the grain cart.

For example, such a determination may be made based on the PTO RPM being at or near zero (or below a certain threshold) for a certain amount of time and/or in combination with a scale weight being at or near zero (or below a certain threshold). Such a determination may also be based on speed. In the case of speed, since the travel speed in the unload/fold field location is low compared to a travel speed to and from the harvester, the speed going above or below a threshold (optionally for a certain amount of time) can trigger, at least in part, an auger fold or unfold event. Alternatively, and/or additionally, cameras or other sensors (e.g., lidar) may be able to detect obstacles around the grain cart and/or in the grain cart travel path, such as the harvester unload auger, the combine unload auger, poles, trees, electrical power, communication transmissions, among other obstacles. In response to detecting obstacles, at least in part, the controller may cause the auger to be folded. In the case of a combine unload auger, a controller in a grain cart could in some embodiments signal or command or coordinate with the harvester to fold the harvester's unload auger. In some cases, the harvester may not want to fold the unload auger (such as if is in the process of unloading into another grain cart), and a controller in the harvester may override or ignore the signal or command from the grain cart. For example, the controller may cause an auger (e.g., an upper auger) of the grain cart to fold when a combine unload auger is in an unload position.

The upper auger may also have multiple transport positions, e.g., a field transport position and a road transport position. When in the field, the upper auger may have an option of being stored in a field transport position that allows less time to move to the unload position. This field transport position may be wider than when it is in a road transport position. A controller may be able to determine if the grain cart is operating on a field or a road and adjust the auger to the field or road transport positions as appropriate, and/or may alert the grain cart operator, farm operations manager, and/or combine harvester operator, and/or may stop the grain cart (e.g., if the grain cart is not in the road transport position when it leaves the field and enters onto a road).

Auger Fold Lockout Based on PTO Speed and/or Weight Change.

There may be couplings between the upper and lower portions of the unload augers to transmit RPM and torque. If the auger moves into or out of the unload position, even when there is no grain running through the augers, it can damage these couplings. This typically happens due to operator error, such as the operator engaging the wrong hydraulic function. For example, the operator may try to shut the flow door, but select the auger fold by mistake. An auger fold lockout can disable the hydraulic function, or ignore a signal or command that is associated with the auger fold, while the PTO RPM is above a threshold (e.g., a very low threshold, such as zero). Alternatively, or additionally, a controller could also monitor weight change and identify that it is in an unload event and ignore or disable auger fold function due to the unload event.

### Making Sure the Flow Door is Shut.

If the flow door is open when it is loaded from a harvester, the grain will flow into the grain cart auger resulting in higher than normal PTO startup torque values, which can create problems (such as the problems described above). In addition, to the grain going into the auger when the auger is not rotating, it can be “packed” from driving through the field and the grain cart bouncing up and down and side to side, making it even worse. Double auger (vertical and horizontal augers) grain carts are more susceptible to this. Commonly the flow door being open is due to the operator not shutting the floor door after the unload event since in some instances the entire grain cart contents are unloaded into the truck container the operator may not have had to close the flow door to limit the amount of grain loaded into the truck and simply forgot or otherwise neglected to shut the flow door. In certain embodiments, a controller may automatically shut the flow door and/or check to make sure the flow door is shut when it is being loaded. A controller may determine it is being loaded, for example, using one or more of: ground speed, PTO speed, an auger position, weight information. For example, during loading a grain cart is most likely to be moving slowly or still (low and/or zero ground speed), with the auger not engaged for unloading (low and/or zero PTO speed and/or auger portion being folded or otherwise not in an unload position). As another example, during loading, the weight of grain in the hopper and/or grain cart is likely to increase (in some embodiments, detecting an increase over a certain threshold may indicate a loading event, either by itself or in combination with one or more other conditions such as those described above). A controller may shut the flow door or verify the flow door is shut in response to identifying that the grain cart is traveling to a harvester, travelling parallel to a harvester, and/or within a certain distance of a harvester.

Automatic Control for Horizontal Auger Engagement/Disengagement from the Cab.

As noted above, double auger grain carts can have different types of mechanical transmissions to drive the horizontal auger(s). In the case of a belt drive, a tensioner is placed so the belts have tension and create friction to drive the auger. The higher the tension, the more friction and higher torque; on the other hand, the lower the tension, there is lower friction and lower rotation. Since the need for disengaging the drag auger belt tensioner is rare, a manual mechanical tensioner is used currently. A controller can automatically unplug a “slugged” grain cart auger and/or step the operator through the process. This may be performed by disengaging and re-engaging the belt tensioner or clutch. Additionally, in certain embodiments, sensors associated with the belt tensioner cylinder such as the hydraulic lines or that sense position of the belt tensioner and/or cylinder can be monitored by the controller as a confirmation that the belt drive or clutch is engaged before starting the unload event or before starting certain steps in the unload event such as opening the flow door. If the hydraulic pressure is low, the belt may not be engaged or there may be some other problem with the belt drive system. Likewise, other types or sensors could be used to determine the position of the cylinder or belt tensioner being engaged or not engaged and could be used as part of this process. Although a cylinder is noted here, other types of actuators may also be employed, such as a linear actuator. The grain cart may utilize a clutch, such as a clutch built in the gearbox, and a controller may engage and disengage this clutch. U.S. Pat. No. 10,743,474 provides an exemplary grain cart utilizing a clutch, the disclosure of which is herein incorporate by reference in its entirety.

### Diagnostic Capability, e.g., for Each Individual Load Cell.

Certain embodiments may provide diagnostic capability. For example, one or more controllers may be able to detect certain conditions on a grain cart and alert an operator or other user about those conditions. Several examples follow.

A controller may determine that the grain cart auger(s) are in a “slugged” condition and alert the operator to this effect. This determination is described above, along with an optional embodiment where the controller can automatically unslug the auger(s). The controller may also guide an operator through the process of deslugging the auger.

A controller may use one or more sensors at the ends (e.g., at or near the extreme ends) of the auger(s) to confirm that the auger(s) are rotating and/or rotating at the anticipated RPM. If the auger(s) are not rotating and/or are not rotating at the anticipated RPM, when the PTO is engaged, the controller may determine that there is a failure (e.g., a failed or damaged drive component or a clutch not completely transmitting torque). The controller may signal an alert about this failure.

A controller may monitor when access points, such as cleanout and hopper doors, are shut and may also monitor when hopper ladders are in a storage position. Cleanout doors are used to empty or access the augers. If these doors are open when augers are rotating it may present a dangerous situation. A less dangerous result would be grain not being held in the auger. The controller may signal an alert when the cleanout doors are open when augers are rotating. The controller may also prevent opening the flow doors or shut the flow door if they are open while the cleanout doors and/or hopper doors are open. If the controller senses open cleanout doors, the controller can prevent or stop an unload event, such as by preventing the flow door from opening or by closing the flow door; the controller may also prevent PTO from engaging or shut the PTO off, engage clutches, disengage belt tensioners, or use other means to stop the augers from rotating.

A controller may monitor when hopper access doors are open/shut. These doors allow entry into the hopper. If open, it could indicate somebody is in the hopper presenting a potentially dangerous situation. A less dangerous result would be grain not being held in the hopper. The controller may signal an alert when the hopper access doors are open. The alert may also be performed in conjunction with preventing some other grain cart action (e.g., an unload event). For example, if hopper access doors are open, a controller may perform one or more of: preventing the flow door from opening, closing the flow door, preventing PTO from engaging, shutting the PTO off, engaging clutches, disengaging belt tensioners, using other means to stop the augers from rotating, and preventing the grain cart and/or tractor from moving.

A controller may monitor one or more sensors on one or more grain cart ladders. If the ladder is left in a certain position, it could potentially mean somebody in the hopper which can be a dangerous situation or a less dangerous situation would be potential damage to the ladder. The controller may signal an alert when a ladder is in a certain position indicating that somebody may be in the hopper. The alert may also be performed in conjunction with preventing some other grain cart action (e.g., an unload event). For example, the tractor PTO may be prevented from engaging (or the tractor PTO may be shut off) based on the ladder position.

A controller may monitor grain cart tire pressure. Low or blown tire pressure can quickly ruin a tire and possibly the wheel also, particularly when there is grain in the grain cart. Tires and wheels are expensive and difficult to replace. In manual operations, the grain cart operator can check the tire pressure or know if a tire is low or blown. Potentially a harvester operator or truck driver may also notice. If in full autonomous operation, there is no grain cart operator so tire pressure could be used to assure that there is no issue of the tires being low or blown. In certain embodiments, other sensors may also be used to indicate an issue with the tire or wheel, such as cameras, inclinometers, or gyroscopes; and, in some embodiments, sensor values may be compared between the tractor and the grain cart to further determine if there is an issue with a tire or wheel. The controller may, for example, send notifications to alert the grain cart operator, farm operations manager, and/or combine harvester operator, such as an alert or audible noise. Note that an alert, generally as used throughout this disclosure, may include one or more of an audible alarm, haptic feedback, and one or more messages (including texts, mobile device notifications, and a phone call such as to the grain cart operator, farm operations manager, and/or combine harvester operator).

A controller may monitor track belt tensions. Typically a grain cart has at least two track assemblies, each having at least one tensioner. Like the grain cart tire pressure, track assemblies are expensive and difficult to fix as well as to replace track belts. Proper tension and alignment are very important for the long life of belts and other track assembly components. In the case of track belt tension, this tension is typically maintained with a hydraulic cylinder or spring assembly. A controller may compare a pressure reading to a predetermined value to determine if there is a problem or potential problem with the track belt tension, and then issue an alert if there is (e.g., if the pressure reading is below a threshold). If use of pressures, the track belt tensioner could use hydraulics or other incompressible fluid and a cylinder, and a target pressure could be 1,000 or 1,200 psi in some embodiments. Hydraulic pressure would be easiest due to the tractor being able to supply hydraulic flow and pressure. Another example could be air which in some countries outside the US is commonly used with the tractor (an airbag may also be used instead of a cylinder in some cases). Based on the track assembly tension cylinder pressure, the controller can adjust the pressure. A controller may detect a pressure switch on the track tension cylinder that if it falls below a threshold, the controller signals an alert. Or the cylinder sensor may provide real time pressures and/or the controller may adjust the pressure based on if the pressure is above or below a targeted range. In such embodiments, the track tensioner may be plumbed to a hydraulic flow source such as the tractor. If it cannot reach the desired pressure, the controller may stop the movement of the grain cart and/or send a notification that the grain cart is stopping or should be stopped. Alternatively, or in addition to adjusting the pressure, the controller may also notify the grain cart operator, farm operations manager, combine harvester operator and/or stop the grain cart. Although a cylinder is noted here, other types of actuators may also be used, such as for example a linear actuator. In addition to monitoring pressure, or alternatively, the controller may in some embodiments measure force, spring rate, spring compressed distance, and/or actuator stroke length, and may take such measurements into account when signaling an alert, stopping the grain cart, adjusting pressure, or otherwise controlling operations.

A controller may monitor track alignment. Each track assembly may have at least one means of keeping the track belt aligned, such as by using a pivoting arm. An out-of-alignment track belt results in heat buildup in the track belt, typically between the belt and the track assembly wheels. The heat build up may also affect the sides of track belt guide lugs. By monitoring areas of the track belt heat, the controller can (i) adjust the alignment (e.g., by some type of actuator), (ii) notify the grain cart operator, farm operations manager, and/or combine harvester operator about the alignment and/or heat issues, and/or (iii) stop the grain cart. Additionally, or alternatively, one or more infrared sensors (including, for example, a camera) may be used to determine if the track is (or is not) in alignment.

A controller may monitor tractor to grain cart setup or and/or perform functional or operational checks. Tractors can be used with multiple implements through the year and even through the harvest season a tractor or grain cart may be disconnected and connected from or to various implements. For example, a tractor may have a mechanical issue and may need servicing; in such a case, it may be replaced by a different tractor, including a different model and/or brand. When a tractor is connected to a grain cart, this typically involves connecting the grain cart hitch to the tractor drawbar, connecting a driveline assembly to the tractor PTO, electrical connections for at least work and transport lights, and hydraulic connection(s).

A tractor can have multiple hydraulic ports for implements to connect to and these ports are used to control and implement functions by directing flow and pressure, stopping flow, or allowing free flow of hydraulic fluid. In some cases there is a switch for dictating the tractor hydraulic flow which is known as the Selective Control Valves (SCV). In many cases, a tractor does not have enough SCVs to control the many grain cart functions such as flow door, auger tilt, auger fold, auger tilt, grain cart steering, and bent tensioner, as examples, so a tractor may have multiple SCVs and ports that are used. When there are multiple sets of hydraulic hoses between the tractor and the grain cart, the connections may not be correctly or completely made. A controller may be used to diagnose potential issues. One diagnostic may be performed when initially hooked up; a controller may check each hydraulic connection as well as checking the grain cart function by running the function. This also can check grain cart sensors associated with that function. The diagnostic can step through each operation, e.g., by instructing the tractor operator to operate the tractor SCV, and may include having the operator provide feedback, or use grain cart sensors to determine, that the function operated properly. The tractor or grain cart controller can use the grain cart sensors to determine what grain cart function was performed by a SCV or tractor hydraulic ports and adapt what grain cart function is associated with that tractor SCV. Alternatively or additionally, since most modern tractor SCV switches are programmable, the controller may ask what function is running or has run and based on the operator feedback it may reprogram the switch associated with that SCV hydraulic port. A controller can assist an operator in making connection adjustments if needed.

A single SCV valve providing a constant pressure port and constant return flow ports, similarly to a Power Beyond option on tractors that provide pressure and flow when the implement has demand, can use an Electrical Over Hydraulic (EOH) valve assembly that directs the hydraulic in similar manner as the SCV's to operate many or all of the grain cart functions. In such a case, a controller may implement diagnostics, such as by checking to make sure proper hydraulic connections and/or grain cart functions such as folding the auger, tilting the auger, opening and closing the flow door, steering the GC wheels, and so on, are working properly. If any of these diagnostics indicate that the hydraulics are not connected properly or that a grain cart function is not working properly, the controller may signal an alert to an operator or other user, assist the operator in addressing the problem, or indicate that further inspection is needed.

A controller may monitor an auger position, such as whether an upper auger is in an auger field transport or road transport position. When in the field, the upper auger may have an option of being in a field transport position that allows less time to move to the unload position. This field position may be wider than when it is in a road transport position. In the case of grain carts with the unload augers on the right-hand side of the cart, the upper unload auger could point to the side of oncoming traffic. The controller may identify if the grain cart auger is not in the road transport position when it leaves the field or is about to leave the field and, if that is the case, signal an alert to the grain cart operator, farm operations manager, and/or combine harvester operator, and/or the controller may stop the grain cart. For example, the controller may determine the grain cart is about to leave the field if the controller senses the tractor electrical connector for the implement lighting has been put into road transport mode (e.g., which may include flashers and/or turn signals), and/or the controller may use GPS or other location tracking technology to determine if it is outside the field map boundary.

A controller may monitor grain cart steering. Some grain carts include tandem wheel assemblies that steer. These wheel assemblies may include caster wheel assemblies that are set in pairs. The castor wheels move about a caster pin but the caster pin does not allow the wheels to spin a full revolution (360°). When the grain cart goes into reverse, for example, the steering is locked in place (e.g., using a EOH valve block specific to the hydraulic steering system and/or a manual switch) or the grain cart operator uses the selective control valve (SCV) to manually steer the grain cart wheels. This locking can be automated if the controller is told or if the controller identifies that the tractor is put into reverse or starts to travel in reverse. Additionally, if a position sensor is placed in the steering system, such as in the steering cylinder, the controller can, in some embodiments, automatically steer the grain cart. In some cases, the controller may steer the grain cart only when traveling in reverse, but in other cases, the controller may steer also when the grain cart is going forward. The controller may also receive other input such as from a sensor that senses an angle between the tractor drawbar and/or GPS locations of the tractor and grain cart. If equipped with a steerable undercarriage (e.g., tires) that have automatic steering, such as what is described in U.S. Pat. Nos. 7,810,823 and 9,205,715; a controller may, in some embodiments, monitor the PTO RPM and, once the PTO RPM goes above a threshold (e.g., above 0, 100, or 150 RPM), the controller may (i) lock the steering tires from changing a steering angle, (ii) determine if the steering tires are not in a predetermined position for unloading and, if not, position the steering tires to be in that predetermind position (e.g., in-line, for straight forward-backward travel), (iii) determine if the steering tires are not in a predetermined acceptable angle and, if not, position the steerable tires to be in that predetermined acceptable angle and, in some cases, prevent the tires' steering angle from changing, and/or (iv) unlock the steer angle until the PTO RPM drops below the threshold (or a different threshold).

A controller may confirm the hydraulic jack is in the proper position (such as up in transport position) and signal an alert if that is not the case. For example, a controller may sense a load on the jack, such as hydraulic pressure on a cylinder, and/or a proximity sensor may be used to determine specific locations of the jack. A controller may use the hitch weight reading to notify or alert a user. For example, a controller may use the hitch weight reading from the hitch load cell such as by comparing it to other load cells in the system to determine that the hydraulic jack is in a lowered position.

A controller may monitor gearbox oil temperature and level. If the gearbox oil temperature reaches or exceeds a threshold and/or if the gearbox oil level is below a threshold, the controller may notify the grain cart operator, farm operations manager, and/or combine harvester operator, and/or may stop the grain cart.

A controller may perform various scale related diagnostics. This may include monitoring output and performance of individual load cells in addition to monitoring the total sum outputs.

In some embodiments, a tractor controller may indicate in its communication to a grain cart controller various operation modes, e.g., such as various levels of autonomy, loading of the grain cart, unloading of the grain cart, field autonomy (e.g., field travel, loading, and/or unloading), and road autonomy. The grain cart controller may use this information (e.g., about various operation modes) to make changes to the implement, allowing and/or preventing some implement functions accordingly. For example, in the case of a grain cart, the grain cart controller may react to a road operation mode by (i) folding the upper auger, (ii) positioning the auger tilt, spout, and/or steering to certain defined positions, and/or (iii) positioning and/or locking steering tires if equipped.

The grain cart controller may, in some embodiments, automatically steer the grain cart, position the wheels to a predetermined position, and/or lock the wheels in place, e.g., based on PTO speed. When the PTO begins to turn or go above a threshold, such as may occur with an unload event next to a trailer or container, the controller may take one or more actions, such as locking the wheel position in its current position. For example, if the controller has wheel position input, it may move the wheels to a predetermined position, such as a straight forward-and-rearward travel position, and then hold that position. Similarly, if the controller has inputs to determine steering between the tractor and grain cart, it may automatically move the wheels to negotiate the turn while the PTO is above the threshold. Once the PTO is below the threshold, the controller may then allow the steering system to return to its previous operating mode (such as automatic).

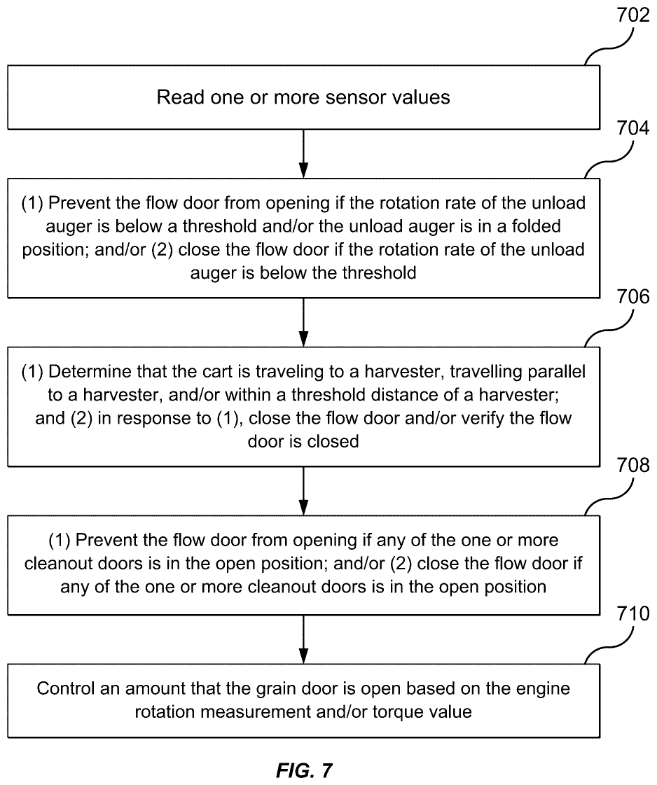

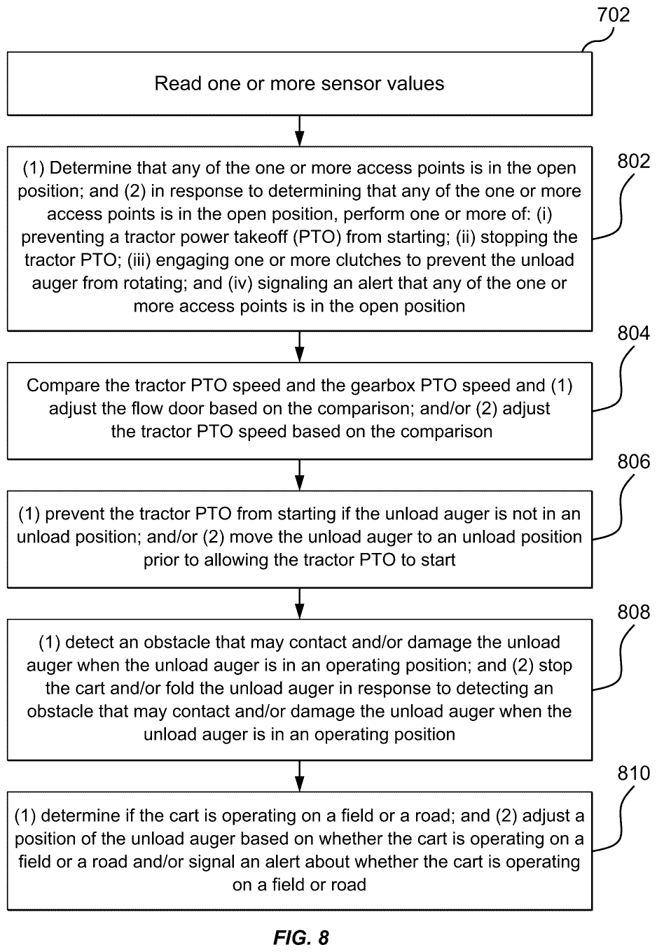

FIGS. 7 and 8 illustrate a flow chart according to an embodiment. Any of the grain carts described herein may be used in connection with the methods here described. One or more sensors may be employed, including any of the sensors described herein. In embodiments, the grain cart is operating in conjunction with a tractor, and the one or more sensors may be deployed with respect to either the grain cart, the tractor, or both. A controller may be provided which can control certain operations on the grain cart and/or tractor, along with processing circuitry which can evaluate inputs received from the one or more sensors and direct the controller to perform various actions.

A method may begin with step 702, reading one or more sensor values.

The method may proceed with one or more of steps 704-710 and 802-810 in any order.

At step 704, the method may include (1) preventing the flow door from opening if the rotation rate of the unload auger is below a threshold and/or the unload auger is in a folded position; and/or (2) closing the flow door if the rotation rate of the unload auger is below the threshold.

At step 706, the method may include (1) determining that the cart is traveling to a harvester, travelling parallel to a harvester, and/or within a threshold distance of a harvester; and (2) in response to (1), closing the flow door and/or verifying the flow door is closed.

At step 708, the method may include (1) preventing the flow door from opening if any of the one or more cleanout doors is in the open position; and/or (2) closing the flow door if any of the one or more cleanout doors is in the open position.

At step 710, the method may include controlling an amount that the grain door is open based on the engine rotation measurement and/or torque value.

At step 802, the method may include (1) determining that any of the one or more access points is in the open position; and (2) in response to determining that any of the one or more access points is in the open position, performing one or more of: (i) preventing a tractor power takeoff (PTO) from starting; (ii) stopping the tractor PTO; (iii) engaging one or more clutches to prevent the unload auger from rotating; and (iv) signaling an alert that any of the one or more access points is in the open position.

At step 804, the method may include comparing the tractor PTO speed and the gearbox PTO speed and (1) adjusting the flow door based on the comparison; and/or (2) adjusting the tractor PTO speed based on the comparison.

At step 806, the method may include preventing the tractor PTO from starting if the unload auger is not in an unload position; and/or (2) moving the unload auger to an unload position prior to allowing the tractor PTO to start.

At step 808, the method may include (1) detecting an obstacle that may contact and/or damage the unload auger when the unload auger is in an operating position; and (2) stopping the cart and/or folding the unload auger in response to detecting an obstacle that may contact and/or damage the unload auger when the unload auger is in an operating position.

At step 810, the method may include (1) determining if the cart is operating on a field or a road; and (2) adjusting a position of the unload auger based on whether the cart is operating on a field or a road and/or signal an alert about whether the cart is operating on a field or road.

Embodiments of the present invention have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

What is claimed is:

1. A system comprising:
a cart including a hopper and an unload auger, the hopper having a flow door configured to release material stored in the hopper into the unload auger when in an open condition;
one or more sensors, at least a first sensor of the one or more sensors being configured to measure a rotation rate of the unload auger;
a controller; and
processing circuitry configured to: (1) prevent the flow door from opening if the rotation rate of the unload auger is below a threshold and/or the unload auger is in a folded position; and/or (2) close the flow door if the rotation rate of the unload auger is below the threshold.

2. The system of claim 1, wherein at least a second sensor of the one or more sensors is configured to determine a position of the cart, wherein the processing circuitry is further configured to: (1) determine that the cart is traveling to a harvester, travelling parallel to a harvester, and/or within a threshold distance of a harvester; and (2) in response to (1), close the flow door and/or verify the flow door is closed.

3. The system of claim 1, wherein the hopper and/or auger comprises one or more cleanout doors, at least a third sensor of the one or more sensors is further configured to detect if the one or more cleanout doors are in a closed position, and the processing circuitry is further configured to: (1) prevent the flow door from opening if any of the one or more cleanout doors is in the open position; and/or (2) close the flow door if any of the one or more cleanout doors is in the open position.

4. The system of claim 1, wherein the controller receives as input an engine rotation measurement and/or torque value related to an engine of a tractor connected to the cart and wherein the processing circuitry is further configured to control an amount that the grain door is open based on the engine rotation measurement and/or torque value.

5. The system of claim 4, wherein the processing circuitry is further configured to determine that the unload auger is in an a plugged condition based on one or more of (i) a rotation rate of the unload auger and the engine rotation measurement, (ii) a torque value related to the engine of the tractor, (iii) a rotation rate of a tractor PTO and a gearbox, (iv) a rotation rate of the unload auger and the tractor PTO, and (v) a rotation rate of the gearbox and the tractor PTO.

6. The system of claim 5, wherein the processing circuitry is further configured, in response to determining that the unload auger is in a plugged condition, perform one or more of: (i) stopping the tractor PTO if it is running; (ii) disengaging the unload auger; and (iii) signaling an alert that the unload auger is in the plugged condition.

7. The system of claim 6, wherein disengaging the unload auger is controlled by a drive belt tensioner.

8. The system of claim 7, wherein disengaging the unload auger comprises engaging one or more clutches to prevent the unload auger from rotating.

9. A system comprising:
a cart including a hopper and an unload auger, the hopper and/or auger comprising one or more access points (e.g., cleanout doors, hopper access doors, ladders);
one or more sensors, at least a first sensor being configured to detect if the one or more access points are in a closed position;
a controller; and
processing circuitry configured to: (1) determine that any of the one or more access points is in the open position; and (2) in response to determining that any of the one or more access points is in the open position, perform one or more of:
(i) preventing a tractor power takeoff (PTO) from starting;
(ii) stopping the tractor PTO;
(iii) engaging one or more clutches to prevent the unload auger from rotating; and
(iv) signaling an alert that any of the one or more access points is in the open position.

10. A system comprising:
a cart including a hopper and an unload auger, the hopper having a flow door configured to release material stored in the hopper into the unload auger when in an open condition;
one or more sensors, at least a first sensor of the one or more sensors being configured to measure a tractor power takeoff (PTO) speed and a gearbox PTO speed;
a controller; and
processing circuitry configured to: compare the tractor PTO speed and the gearbox PTO speed and (1) adjust the flow door based on the comparison; and/or (2) adjust the tractor PTO speed based on the comparison.

11. A system comprising:
a cart including a hopper and an unload auger, the hopper having a flow door configured to release material stored in the hopper into the unload auger when in an open condition;
one or more sensors configured to measure a tractor power takeoff (PTO) speed;
a controller; and
processing circuitry configured to: (1) prevent the tractor PTO from starting if the unload auger is not in an unload position; and/or (2) move the unload auger to an unload position prior to allowing the tractor PTO to start.

12. A system comprising:
a cart including a hopper and an unload auger;
one or more sensors, at least a first sensor of the one or more sensors being configured to detect obstacles;
a controller; and
processing circuitry configured to: (1) detect an obstacle that may contact and/or damage the unload auger when the unload auger is in an operating position; and (2) stop the cart and/or fold the unload auger in response to detecting an obstacle that may contact and/or damage the unload auger when the unload auger is in an operating position.

13. The system of claim 12, wherein the one or more sensors includes one or more of a camera, a radar sensor, a lidar sensor, an infrared sensor, and an ultrasonic sensor.

14. A system comprising:
a cart including a hopper and an unload auger;
one or more sensors, at least a first sensor of the one or more sensors being configured to detect a position of the unload auger and a position of the cart;
a controller; and
processing circuitry configured to: (1) determine if the cart is operating on a field or a road; and (2) adjust a position of the unload auger based on whether the cart is operating on a field or a road and/or signal an alert about whether the cart is operating on a field or road.

15. The system of 14, wherein adjusting a position of the unload auger based on whether the cart is operating on a field or a road comprises moving the unload auger to a transport position for traveling on a road.
